(19) United States
(12) Patent Application Publication
(10) Pub. No.: US 2012/0029894 A1
(43) Pub. Date: Feb. 2, 2012

(54) INFORMATION PROCESSING APPARATUS AND INFORMATION PROCESSING METHOD

(75) Inventor: Naoto Okutani, Kawasaki-shi (JP)

(73) Assignee: CANON KABUSHIKI KAISHA, Tokyo (JP)

(21) Appl. No.: 13/189,258

(22) Filed: Jul. 22, 2011

(30) Foreign Application Priority Data
Jul. 30, 2010 (JP) 2010-172931

(51) Int. Cl. G06G 7/50

(52) U.S. Cl. 703/9

(57) ABSTRACT

An information processing apparatus for generating a thermal analysis model for a plurality of component models includes a gap simplification unit configured to simplify a gap area having a gap between the plurality of component models by generating a gap model based on an extracted portion of the gap area and by merging the gap using a modification of a component model which contacts the gap, an extraction unit configured to extract a merged face using the gap model and the merged gap, a calculation unit configured to calculate thermal resistance of the merged face based on a thermal conductivity and the merged face, and an assigning unit configured to assign the thermal resistance to the merged face.

### BACKGROUND OF THE INVENTION

1. Field of the Invention

Embodiments of the present invention relate to information processing used for generating a thermal analysis model from a geometric model.

2. Description of the Related Art

Nowadays, computer aided design (CAD) is widely used in designing components and products. Among the various methods for utilizing a three-dimensional (3D) CAD model (hereinafter referred to as the CAD model) obtained by CAD, there is an analysis using finite element method.

When a product is analyzed by a CAD model, if a portion of the product has a complex or a minute geometry, meshes of that portion will be dense. Since long processing time is required when the meshes are dense, simplification of the shapes (hereinafter referred to as simplification) is generally performed. According to the simplification, the component geometry is simplified but the analysis accuracy is also maintained to a certain degree of accuracy. If a CAD model is used for thermo-fluid analysis, the meshes are generated not only for the components of the product but also for the analytical space. Thus, if a small gap exists between the components, the geometry of the analytical space will be complex and a considerable amount of calculation time will be necessary as is with the case where the components have a complex geometry.

Thus, generally, to simplify the analytical space, the user determines a portion which is considered to have a smaller influence on the analysis result and then fills the small gap between the components. To reduce the load of such operations, a method for filling a gap between components has been proposed.

Japanese Patent Application Laid-Open No. 2004-265050 discusses a method that divides a component into a plurality of plane elements, measures a distance between each plane element and an element of a component that faces the plane element, extracts only the plane elements which are in the gap area, and generates a gap model using the extracted plane elements.

According to the conventional method, however, since the shape of the gap area depends on the division method of the components, if the gap area between the components has minute steps, the gap area will be divided for each of the small steps, and the reduction effect of analysis scale is reduced.

Further, when the thermo-fluid analysis is used, if the gap is simply filled, the accuracy of the analysis may be reduced. For example, if a gap between two components that do not contact each other is filled, the thermal behavior of the product using the obtained components and the thermal behavior of the actual product will be different. Thus, according to the above-described technique, although it is possible to simply fill the gap, the actual thermal behavior may not be correctly reproduced by filling the gap.

Under such circumstances, the user needs to manually simplify a gap while confirming which of the gaps does not significantly affect the analysis. This operation takes a considerable amount of time and effort.

### SUMMARY OF THE INVENTION

Embodiments of the present invention are directed to an apparatus and a method useful in efficiently generating an analysis model with increased analysis accuracy.

According to an aspect of one embodiment, an information processing apparatus for generating a thermal analysis model for a plurality of component models includes a gap simplification unit configured to simplify a gap area having a gap between the plurality of component models by generating a gap model based on an extracted portion of the gap area and by merging the gap using a modification of a component model which contacts the gap, an extraction unit configured to extract a merged face using the gap model and the merged gap, a calculation unit configured to calculate thermal resistance of the merged face based on a thermal conductivity and the merged face, and an assigning unit configured to assign the thermal resistance to the merged face.

Further features and aspects of one or more embodiments will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an information processing apparatus according to a first exemplary embodiment of the present invention.

FIG. 2 is a flowchart illustrating processing flow of the information processing apparatus according to the first exemplary embodiment.

FIG. 3 illustrates an example of thermal conductivity input processing.

FIG. 4 illustrates an example of threshold value input processing.

FIGS. 5A to 5D illustrate extraction processing of a portion to be simplified.

FIGS. 6A to 6D illustrate gap model generation processing of a gap area.

FIG. 7 illustrates merge processing of a gap area with a component.

FIG. 8 illustrates reduced analysis scale according to simplification of a gap.

FIG. 9 illustrates a newly-generated contact face.

FIG. 10 illustrates an example of a list of assigned thermal resistance.

### DESCRIPTION OF THE EMBODIMENTS

Various exemplary embodiments, features, and aspects of the invention will be described in detail below with reference to the drawings.

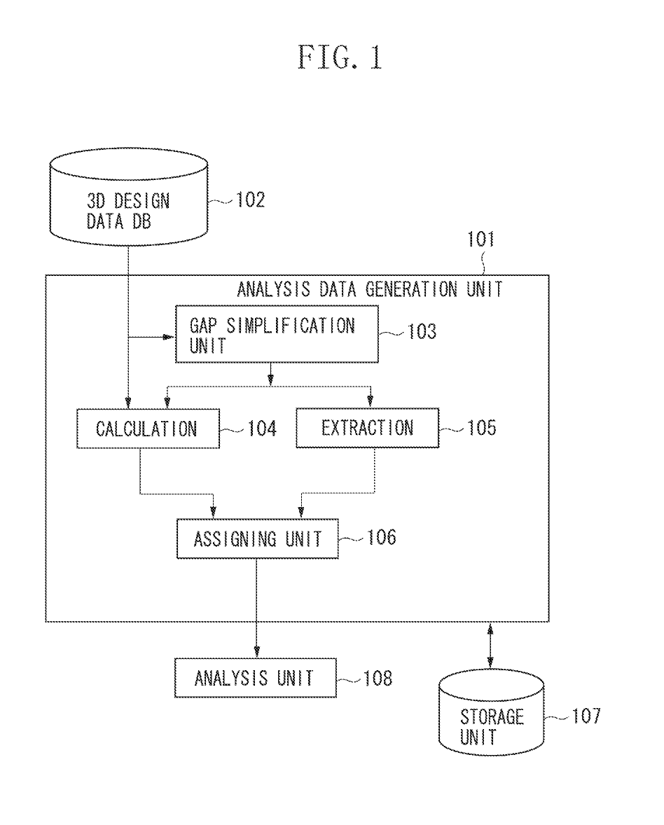

FIG. 1 is a block diagram illustrating a configuration of an information processing apparatus or machine according to a first exemplary embodiment of the present invention. A central processing unit(CPU)or apparatus(not shown) included in the information processing apparatus executes control of each unit described below. The information processing apparatus also includes a read-only memory (ROM) (not shown) and a random access memory (RAM) (not shown) which the CPU uses in reading/writing information when the CPU executes calculation processing.

A 3D CAD model includes a plurality of component models (hereinafter also simply referred to as components). The component models may represent any 3D or solid components, parts, or devices. These components, parts, or devices are physical objects or entities that are concrete and tangible. Examples of these components, parts, or devices may include mechanical or structural parts or components (e.g., vehicle engines), biological parts (e.g., human organs), electro-mechanical parts or components, etc. Design data, which is component data of each component model, is input from a 3D design data database (DB)102 into an analysis data generation unit 101. The design data includes data of the geometric model as well as attribute information and geometric information of the geometric model. Further, from the input design data, the analysis data generation unit 101 generates analysis data which an analysis unit 108 uses when the thermo-fluid analysis is performed. The analysis data generation unit 101 includes a gap simplification unit 103, a thermal resistance calculation unit 104, a contact face extraction unit 105, and a thermal resistance assigning unit 106. Each of the above units may be implemented by a machine or processor executing instructions that perform operations or functions described below, a logic circuit, a state machine, a programmable device, or a combination of any of them.

The gap simplification unit 103 simplifies the gap area between components by the 3D design data of the CAD model obtained from the 3D design data DB 102. The gap simplification unit 103 performs this operation by generating a gap model based on an extracted portion of the gap area and by merging the gap using a modification of a component model which contacts the gap. The gap simplification unit 103 may include a number of units to perform subtasks or sub-functions. For example, the gap simplification unit 103 may include an identification unit to identify a gap between the component models using a threshold value, a merge unit to merge a gap using a component model which contacts the gap, a dividing unit to divide the gap model into portions, etc. The thermal resistance calculation unit 104 calculates the thermal resistance of the gap area simplified by the gap simplification unit 103. The contact face extraction unit 105 extracts a contact face (e.g., merged face) of the gap area simplified by the gap simplification unit 103. The thermal resistance assigning unit 106 assigns the thermal resistance calculated by the calculation unit 104 to the contact face extracted by the contact face extraction unit 105. A storage unit 107 forms, for example, a list of information of the thermal resistance assigned to each component by the thermal resistance assigning unit 106 and stores the list. The analysis unit 108 receives as inputs the analysis data generated by the analysis data generation unit 101 and the thermal resistance information corresponding to the analysis data generated by the analysis data generation unit 101 and stored in the storage unit 107. Then the analysis unit 108 performs the thermo-fluid analysis. The storage unit 107 may be included in the analysis data generation unit 101.

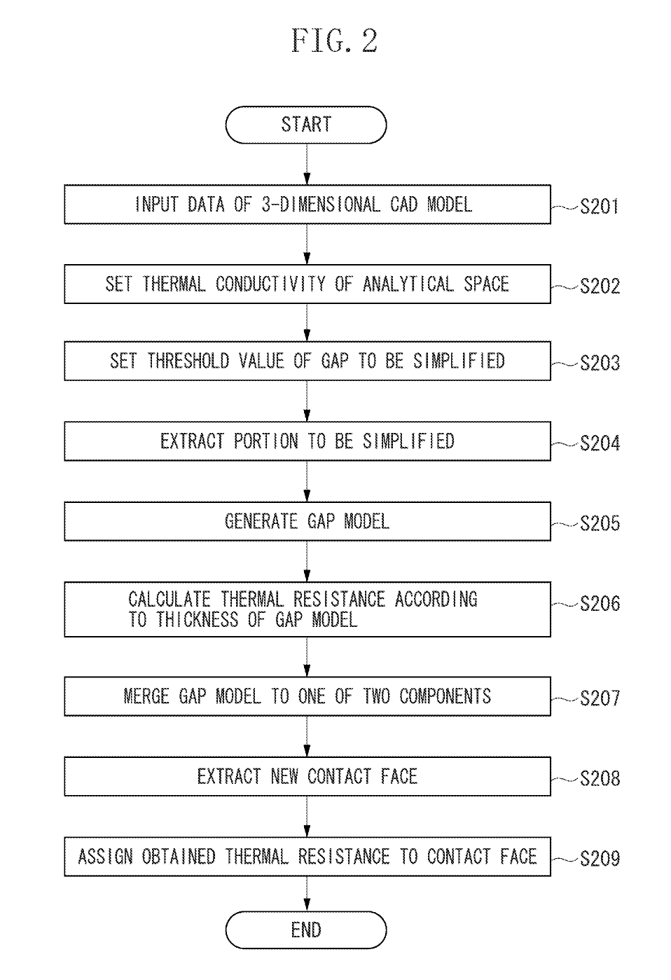

Next, the processing flow of the information processing apparatus according to the present exemplary embodiment will be described with reference to FIG. 2. The processing and the control of the processing may be executed by the CPU of the information processing apparatus or machine, or the logic circuit, the state machine, or the programmable device that performs the described operations.

In step S201, the CPU inputs design data of a CAD model being a design target in the gap simplification unit 103 from the 3D design data DB 102. The design data of the CAD model may be input from a different computer system connected via a network or from an external storage medium of the computer system.

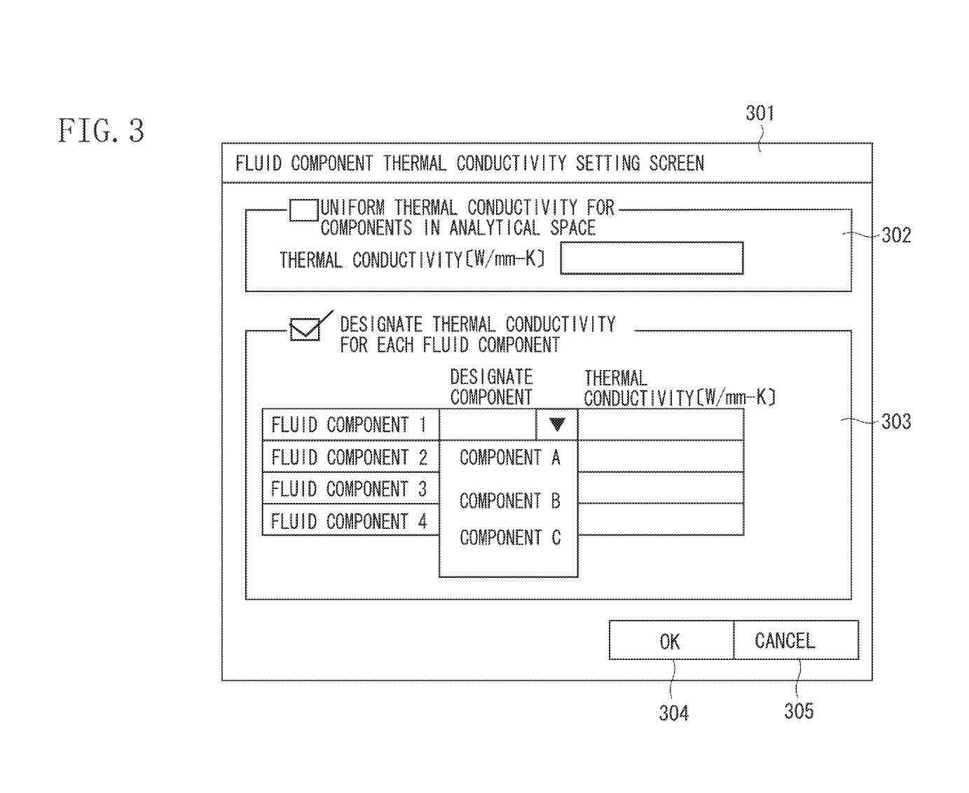

In step S202, the thermal resistance calculation unit 104 sets, selects, determines, or obtains thermal conductivity of a fluid component of the CAD model including a plurality of components and whose data is input in step S201. The fluid component is a fluid area which fills the analytical space excluding the components of the CAD model. An example of a thermal conductivity setting screen used for inputting thermal conductivity of a fluid component is illustrated in FIG. 3. On a thermal conductivity setting screen 301, the user selects a checkbox 302 when the user sets uniform thermal conductivity to the entire analytical space. If the user marks the checkbox 302, a fixed thermal conductivity is set as the thermal conductivity of the fluid component. Further, if the user marks a checkbox 303 used for designating an arbitrary fluid component, the thermal conductivity designated by the user for each fluid component is set as the thermal conductivity of the designated fluid component.

If the user selects a button 304, the thermal conductivity which has been set is determined. If the user selects a button 305, the thermal conductivity which has been set will be cancelled.

Although the user arbitrarily inputs the thermal conductivity according to the present exemplary embodiment, if the thermal conductivity of the analytical space is set in advance in a program or the like, the processing in step S202 may be omitted.

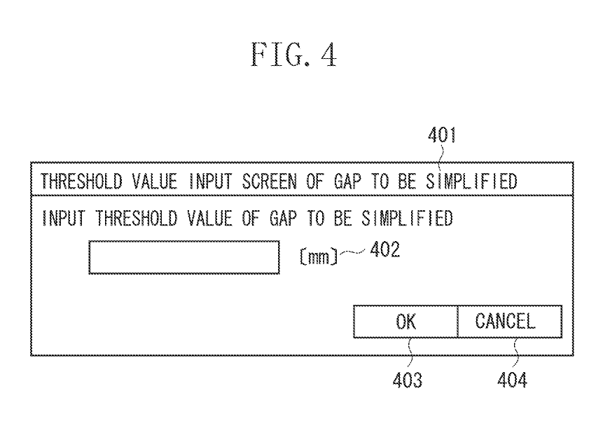

In step S203, the gap simplification unit 103 sets, selects, obtains, determines, or initializes a threshold value of a gap between components to be simplified of the CAD model input in step S201. An example of a threshold value input screen used for inputting a threshold value “th” of the gap between components is illustrated in FIG. 4. The user designates an arbitrary threshold value 402 and sets the value on the threshold value input screen 401 for the gap to be simplified. According to the present exemplary embodiment, the threshold value is set to 0.1 mm (th=0.1).

If the user selects a button 403, the threshold value which has been set will be determined. If the user selects a button 404, the threshold value which has been set will be cancelled.

Although the user arbitrarily inputs a threshold value according to the present exemplary embodiment, if a threshold value of the gap to be simplified is set in advance in a program or the like, the processing in step S203 may be omitted.

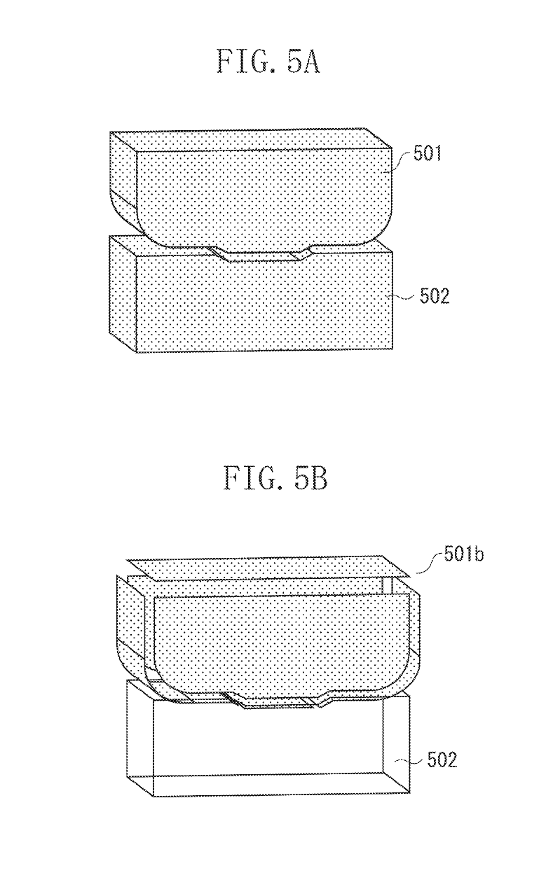

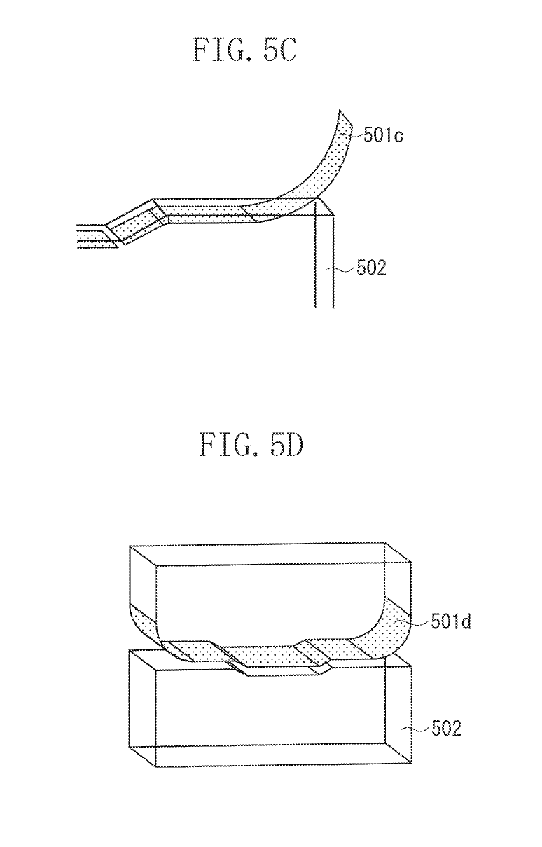

In step S204, the gap simplification unit 103 extracts the portion of the gap to be simplified based on the threshold value input in step S203. An example of the processing for extracting the portion to be simplified is illustrated in FIGS. 5A to 5D. In the description below, a component 501 and a component 502 in FIG. 5A are the target components to be processed.

First, as illustrated in FIG. 5B, each face (e.g., surface) of the component 501 are extracted using attribute information of the design data. Then, each piece of a surface 501b which is obtained by modifying or performing offset of the component 501 is generated. The modification or the offset of the component 501 is performed by pressing each surface piece included in the surface 501b obtained according to the following expression outward in a normal direction defined by the design data and away from the component 501 for the threshold value set in step S203.

If the components of a normal unit vector of each surface are expressed as (A, B, C) and geometric information of each surface before the offset is set as (Xb, Yb, Zb), then the geometric information (Xa, Ya, Za) after the offset is expressed as (Xb+Ath, Yb+Bth, Zb+Cth).

Next, as illustrated in FIG. 5C, whether each surface piece 501c which has been pressed outward interferes with the component 502 is determined using geometric information of the design data of the component 502 and geometric information of the surface piece 501c. As a result of the determination, an identifier (ID) of a surface piece, which is determined to interfere with the component 502, is stored in the storage unit 107 and other surface pieces are deleted. In other words, they are not stored in the storage unit 107.

Next, as illustrated in FIG. 5D, the surface is put back to the state before the offset. Then, based on the geometric information of the design data, the surface pieces adjacent to each other before the offset are merged, and a surface 501d is generated. According to this processing, the surface which contacts the gap whose distance between the components is smaller than the threshold value is extracted, and the portion to be simplified is determined. The gap, therefore, may be identified by the identification unit by comparing the threshold value and a distance between the components.

Although the portion to be simplified is specified by offsetting the surface in the above-described example, such a portion maybe determined by a different method. For example, by acquiring the shortest distance between each surface piece of the component 501 and the component 502 from each piece of design data and extracting only the surface set at a distance smaller than a threshold value, the portion to be simplified may be determined.

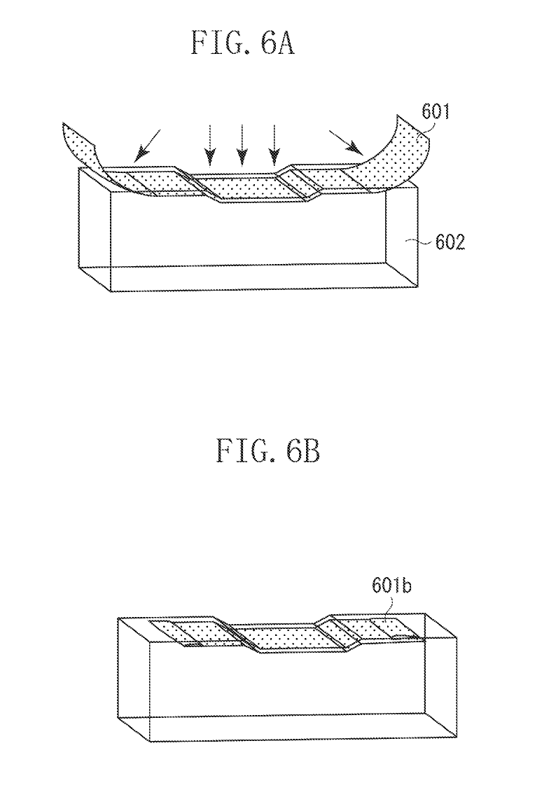

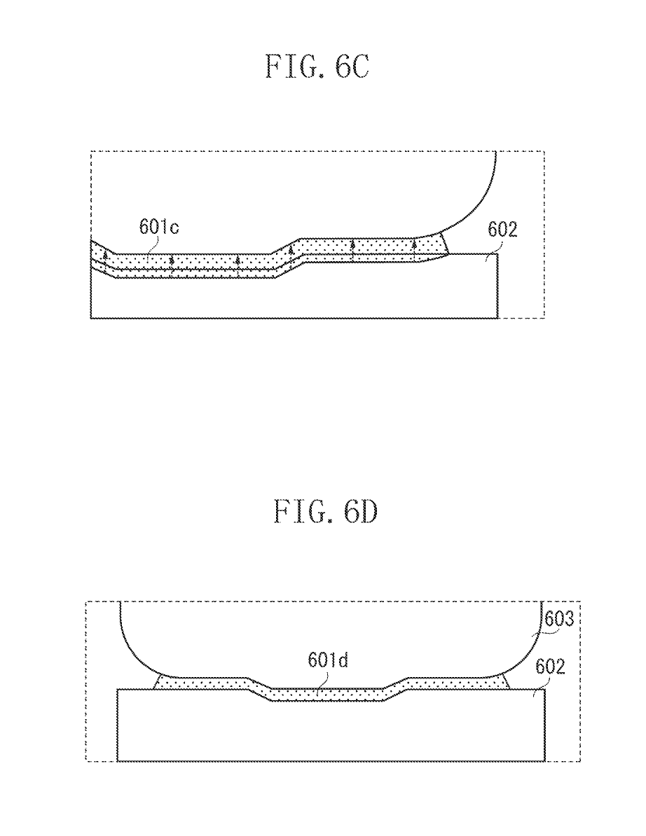

In step S205, the gap simplification unit 103 generates a gap model that fills the gap area between the components based on the portion or surface extracted in step S204. An example of the gap model generation processing is illustrated in FIGS. 6A to 6D.

First, as illustrated in FIG. 6A, a surface corresponding to the portion extracted in step S204 is offset away from the component in a normal direction for a threshold value set in step S203 using the expression above. Accordingly, a surface 601 is generated. In contrast to the processing in step S204, since the offset is performed in a state where the plurality of surfaces are merged (the state of the surface 501d illustrated in FIGS. 5A to 5D), the merged state of the surfaces is maintained even after the offset is performed.

Next, based on the geometric information of a component 602 and the surface 601, the portions where the components interfere with each other are extracted, and a surface 601b is generated as illustrated in FIG. 6B. According to the example illustrated in FIG. 6B, an intersection of the surface 601b and the component 602 is obtained. The geometric information of the intersection is calculated based on the geometric information of the surface 601b and the component 602.

Next, a model 601c in FIG. 6C is generated by offsetting the surface 601b which has been generated for an amount same as the amount which has been offset in the direction opposite to the direction when the processing in FIG. 6A is performed. Specifically, by adding an offset amount to geometric information of the surface 601b and the intersection, the model 601c is generated.

If the size of the gap area between the components and the threshold value do not match, in other words, if the threshold value is greater than the size of the gap area, a portion (e.g., an overlapping portion) where the model 601c interferes with the component 602 according to the offset is generated. Thus, by the geometric information of the generated model 601c and the geometric information of the component 602, the portion where the interference occurs is deleted, and a gap model 601d illustrated in FIG. 6D is generated.

Further, since the contact faces (e.g., merged faces) where the gap model 601d contacts either the component 602 or a component 603 will be the faces to which the thermal resistance is assigned at a later time, each of the contact faces is extracted and stored in the storage unit 107.

In step S206, the thermal resistance calculation unit 104 calculates the thermal resistance according to the thickness of the gap model using the geometry of the gap model generated in step S205. According to this calculation in step S206, the thickness of the gap model generated in step S205 is obtained by the volume obtained from the design data input in step S201 and the area of the contact face stored in step S205. If the gap model has a beveled face with respect to the above-described contact face, and since the thickness of the gap model may be different, an average thickness may be calculated.

Next, the fluid component to which the gap model is included is determined, and the thermal conductivity input in step S202 is set as the thermal conductivity of the gap model. Based on the information of this thermal conductivity and the thickness, the thermal resistance corresponding to the thickness of the gap area is calculated according to the following equation.

R=L/(A×λ)

where R is the thermal resistance, λ is the thermal conductivity of the fluid, L is the thickness of the gap area, and λ is the contact area. As for the thermal conductivity of the fluid λ, if the fluid component is designated in step S202, λ will be the thermal conductivity of the designated fluid component.

In the calculation of the thermal resistance above, the velocity of the fluid that flows through the gap area is considered to be very small so that it may be ignored, and the gap model is regarded as a solid.

Although the thermal resistance is calculated based on the thickness of the gap model in the description above, the gap model may be divided into a plurality of portions, and the thermal resistance may be calculated for each of the divided portions of the gap model.

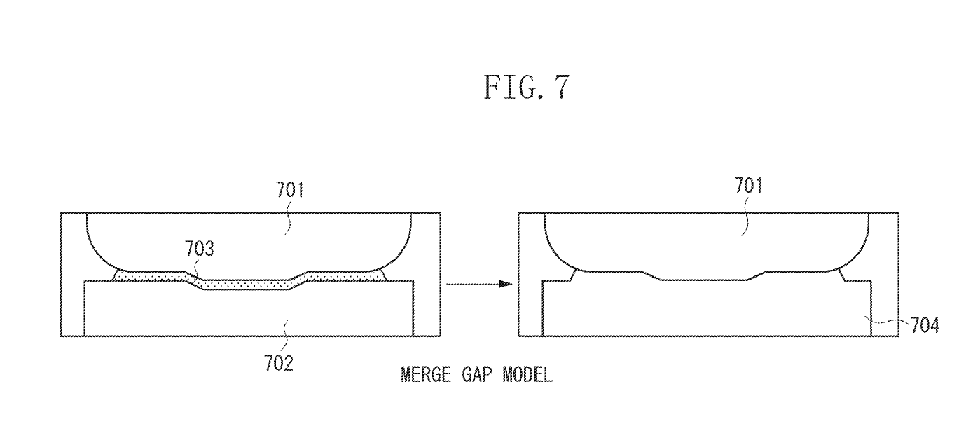

In step S207, the gap simplification unit 103 merges the gap model generated in step S205 with the adjacent component. An example of the merge processing is illustrated in FIG. 7. In FIG. 7, components 701 and 702 are adjacent to a gap model 703. First, the volume of the component 701 and the volume of the component 702 are compared using the volumes obtained from the design data input in step S201. Then, the gap model is merged with the component 702 having a larger volume. This is because if a gap model is merged with a component, the volume of that component becomes larger. Thus, in order to reduce the change in the modulus of the volume change, the component having a larger volume is selected using the geometric information. Then, the gap model is merged with the selected component.

Although the gap model is merged with a component having a larger volume in the description above, the gap model may be merged with a component having a larger heat capacity or with a component whose shortest edge length after the merge is the longest. Further, the component to be merged may be determined not automatically but according to the instruction given by the user. Furthermore, although a gap model is generated by performing offset in the example above, for example, the gap model may be generated by modifying a part of one component (e.g., the component with a larger volume) of the two components.

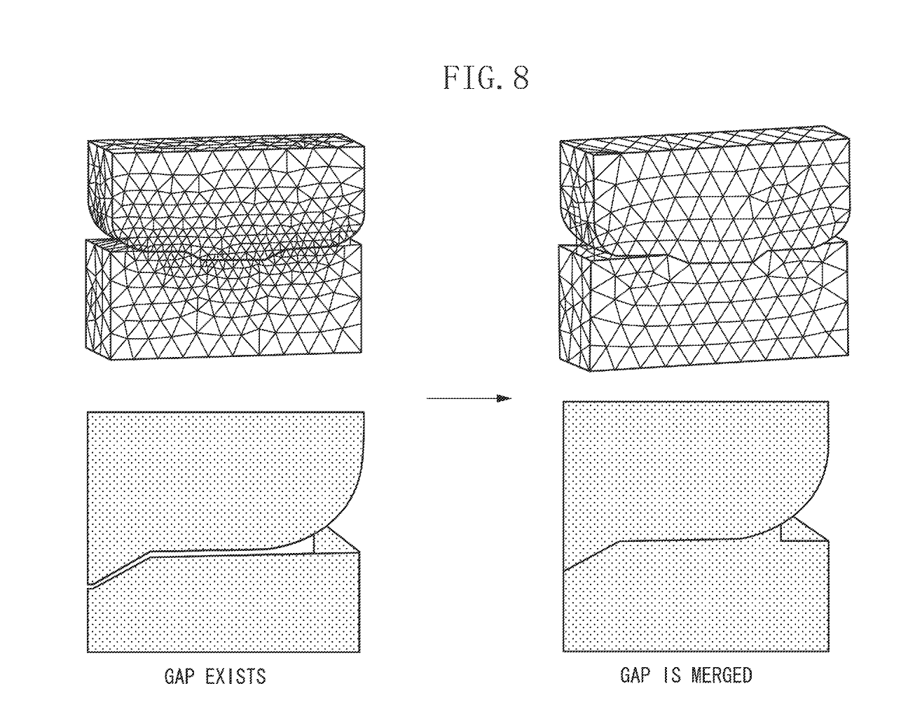

As described above, by merging the gap model with the component, the gap between the components is filled, and a CAD model whose shape of the gap area is simplified is newly generated. According to this simplification, as illustrated in FIG. 8, the meshes in the gap area may be rough, and the analysis scale may be reduced.

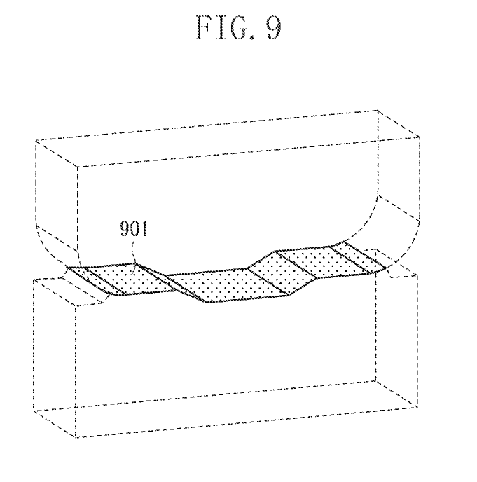

In step S208, the contact face extraction unit 105 extracts the contact face newly generated by the merge of the gap model performed in step S207 from the geometric information of the gap model. First, the contact face after the merge is determined using the contact face extracted in step S205 and the component merged in step S207. Then, a surface such as a surface 901 illustrated in FIG. 9 is extracted.

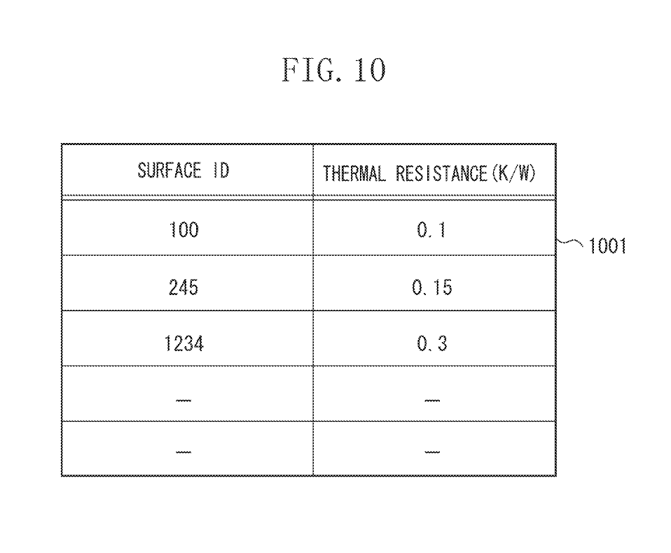

In step S209, the thermal resistance assigning unit 106 assigns the thermal resistance calculated in step S206 to the surface 901 extracted in step S208, forms a list of the information, and stores the list. An example of the thermal resistance information list is illustrated in FIG. 10.

After such processing, a new CAD model generated according to the above-described processing maybe used as the thermal analysis model. In other words, by inputting this analysis model and the thermal resistance information list in the analysis unit 108, the thermal analysis processing may be executed.

The analysis processing may include analysis, evaluation, and optimization processing. Further, the analysis, the analysis and the evaluation, or the analysis, the evaluation, and the optimization may be performed. Further, the processing of the present exemplary embodiment is not limited to the above-described processing flow. For example, the thermal resistance may be calculated after a merged face is extracted.

Further, the present invention may be also achieved by supplying a storage medium storing a software program code which is configured to realize a function (e.g., the function described in the above-described flowchart) of the above-described exemplary embodiment, to a system or an apparatus and reading out and executing the program code or instructions stored in the storage medium by a machine, a processor, a computer (or CPU or MPU) of the system or the apparatus.

According to the above-described embodiment, the thermal resistance is assigned after the simplification gap is filled. Since this operation is automatically performed, time necessary in identifying the portion to be simplified by visual examination and time necessary in executing the simplification processing in a case where the simplification is manually performed may be reduced and an analysis model may be efficiently generated.

### Other Embodiments

Aspects of the present invention may also be realized by a machine or computer of a system or apparatus or processor (or devices such as a CPU or Main Processor Unit/Microprocessor Unit (MPU) that reads out and executes a program or instructions recorded/stored on a memory device or a non-transitory storage medium to perform the operations or functions of the above-described embodiments, and by a method, the steps of which are performed by a computer of a system or apparatus by, for example, reading out and executing a program or instructions recorded/stored on a memory device or a non-transitory storage medium to perform the operations or functions of the above-described embodiments. The method may be a computerized method to perform the operations with the use of a computer, a processor, or a programmable device. The operations in the method involve physical objects or entities (e.g., 3D mechanical parts) and/or transform the elements or parts in the component models from one state to another state. For example, a gap between the component models representing a physical entity is transformed into a gap model and a merged gap. For this purpose, the program/instructions is/are provided to the computer for example via a network or from a recording medium of various types serving as the memory device (e.g., computer-readable medium). In such a case, the system or apparatus, and the recording medium where the program/instructions is/are stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-172931 filed Jul. 30, 2010, which is hereby incorporated by reference herein in its entirety.

What is claimed is:

1. An information processing apparatus for generating a thermal analysis model for a plurality of component models, the apparatus comprising:
a gap simplification unit configured to simplify a gap area having a gap between the plurality of component models by generating a gap model based on an extracted portion of the gap area and by merging the gap using a modification of a component model which contacts the gap;
an extraction unit configured to extract a merged face using the gap model and the merged gap;
a calculation unit configured to calculate thermal resistance of the merged face based on a thermal conductivity and the merged face; and
an assigning unit configured to assign the thermal resistance to the merged face.

2. The information processing apparatus according to claim 1, wherein the gap simplification unit generates the gap model according to the modification, and merges the gap model with one component model out of the component models which contact the gap.

3. The information processing apparatus according to claim 2, wherein the modification is pressing-out modification that presses out a face, which contacts the gap, of the component model that contacts the gap for a length corresponding to the threshold value.

4. The information processing apparatus according to claim 3, wherein the gap simplification unit generates the gap model by performing the pressing-out modification for one component model out of the component models that contact the gap, performing modification of the face that contacts the gap in a direction opposite to a direction of the pressing-out modification such that the face that contacts the gap is changed to a state before the pressing-out modification, and reducing a portion where the face interferes with another component model due to the pressing-out modification.

5. The information processing apparatus according to claim 4, wherein the gap simplification unit merges the gap model with a component model of a larger volume out of the component models which contact the gap.

6. The information processing apparatus according to claim 4, wherein the gap simplification unit merges the gap model with a component model of a larger heat capacity out of the component models which contact the gap.

7. The information processing apparatus according to claim 4, wherein the gap simplification unit merges the gap model with a component model having a longer minimum edge length after the merge out of the component models which contact the gap.

8. The information processing apparatus according to claim 1, wherein the gap simplification unit identifies the gap by comparing the threshold value and a distance between the plurality of component models.

9. The information processing apparatus according to claim 1, wherein the thermal conductivity is different for each of the plurality of component models.

10. The information processing apparatus according to claim 1, wherein the calculation unit calculates the thermal resistance according to thickness of the gap.

11. The information processing apparatus according to claim 4, further comprising a dividing unit configured to divide the gap model into portions;
wherein the calculation unit calculates thermal resistance for each of the divided portions.

12. The information processing apparatus according to claim 4, further comprising an analysis unit configured to perform thermo-fluid analysis on analysis data provided by the simplification unit, the calculation unit, the extraction unit, and the assigning unit.

13. The information processing apparatus according to claim 1, wherein the component data includes geometric information of the component model.

14. An information processing method for generating a thermal analysis model for a plurality of component models, the method comprising:
simplifying a gap area having a gap between the plurality of component models by generating a gap model based on an extracted portion of the gap area and by merging the gap using a modification of a component model which contacts the gap;
extracting a merged face using the gap model and the merged gap;
calculating thermal resistance of the merged face based on a thermal conductivity and the merged face; and
assigning the thermal resistance to the merged face.

15. A computer- readable storage medium for storing instructions that, when executed by a machine or a processor, cause the machine or the processor to perform thermal analysis operations comprising:
simplifying a gap area having a gap between the plurality of component models by generating a gap model based on an extracted portion of the gap area and by merging the gap using a modification of a component model which contacts the gap;
extracting a merged face using the gap model and the merged gap;
calculating thermal resistance of the merged face based on a thermal conductivity and the merged face; and
assigning the thermal resistance to the merged face.
